(19) United States
(12) Patent Application Publication
(10) Pub. No.: US 2025/0151823 A1
(43) Pub. Date: May 15, 2025

(54) RUBBER-DIPPED GLOVE WITH WEAR-RESISTANT FINGERS AND PRODUCTION METHOD THEREOF

(71) Applicant: HuiHong (Nantong) Safety Products Co.Ltd., Jiangsu (CN)

(72) Inventor: Dongliang LIN, Jiangsu (CN)

(73) Assignee: HuiHong (Nantong) Safety Products Co.Ltd., Jiangsu (CN)

(21) Appl. No.: 18/389,608

(22) Filed: Dec. 19, 2023

(30) Foreign Application Priority Data
Nov. 9, 2023 (CN) 202311487077.1

(51) Int. Cl. A41D 19/00

(52) U.S. Cl. CPC A41D 19/0065; A41D 2500/10; A41D 2500/54; A41D 2600/20

(57) ABSTRACT

The present invention belongs to the technical field of labor protection supplies, and specifically, relates to a rubber-dipped glove with wear-resistant fingers and a production method. The rubber-dipped glove comprises a glove core and rubber-dipped layers comprising a finger rubber-dipped layer and a palm rubber-dipped layer, wherein the palm rubber-dipped layer is fixed on surfaces of the glove core and the finger rubber-dipped layer, and the finger rubber-dipped layer is embedded in knitting gaps of fingers of the glove core. The rubber-dipped glove of the present invention has wear resistance and durability, as well as anti-toxic and anti-chemical functions, while ensuring a wearer's flexibility, stability and safety in actual use. Moreover, the rubber-dipped glove has an external surface with no sense of layering and good in aesthetics, and thus the wearer is more willing to wear it.

### CROSS-REFERENCE TO RELATED APPLICATION

This application claims the priority benefit of China application serial no. 202311487077.1, filed on Nov. 9, 2023. The entirety of the above-mentioned patent application is hereby incorporated by reference herein and made a part of this specification.

### BACKGROUND

### Technical Field

The present invention belongs to the technical field of labor protection supplies, and specifically, relates to a rubber-dipped glove with wear-resistant fingers and a production method.

### Description of Related Art

Rubber-dipped gloves are widely used labor protection supplies. They may be used in household, industrial, medical, beauty and other industries, and are essential hand protection supplies. In order to improve wear resistance and durability of the rubber-dipped gloves, at present, chemical and physical means have been used to treat the rubber-dipped gloves. Although the chemical means can be achieved by adjustment of the composition of nitrile latex and modification, they have a long research and development cycle, a low conversion rate, and a high production cost. The physical means are achieved mainly by increasing the overall thickness of the glove, which, however, may increase the usage of rubber-dipping rubber material, and does not improve the performance of the fingers of the glove in a targeted manner.

In the prior art, there are studies on increasing the wear-resistance and durability of the fingers of the rubber-dipped gloves. For example, Patent Application CN113116010A discloses a nitrile glove with wear-resistant fingers and a production method thereof, etc., in which applicability and application thickness of nitrile latex are improved by treating a body of a nitrile glove with a synergist, whereby the problems caused by improving the wear resistance and durability of rubber-dipped gloves using the chemical and physical means are solved. However, in the existing rubber-dipped gloves with wear-resistant fingers, the wear resistance of the fingers is increased only by means of the synergist, so that it is difficult to ensure the wear resistance of the fingers in actual use, resulting in poor durability of the fingers, thus affecting normal operation of wearers. Moreover, the existing rubber-dipped gloves with wear-resistant fingers are made by rubber-dipping the entirety and then rubber-dipping fingertips, resulting in a sense of layering, and thus poor aesthetics of the gloves. Therefore, there is a need for a new technical solution to solve the above technical problems.

### SUMMARY

An object of the present invention is to provide a rubber-dipped glove with wear-resistant fingers and a production method thereof, so as to solve the problems presented in the above background of the invention that it is difficult for the current rubber-dipped gloves with wear-resistant fingers to ensure their wear resistance in actual use, resulting in poor durability of the fingers, thus affecting normal operation of the wearers, and that the existing rubber-dipped gloves with wear-resistant fingers are made by rubber-dipping the entirety and then rubber-dipping fingertips, resulting in a sense of layering, and thus poor aesthetics of the gloves.

In order to achieve the above object, the present invention provides the following technical solutions. A rubber-dipped glove with wear-resistant fingers, comprising a glove core and rubber-dipped layers comprising a finger rubber-dipped layer and a palm rubber-dipped layer, wherein the palm rubber-dipped layer is fixed on surfaces of the glove core and the finger rubber-dipped layer, the finger rubber-dipped layer is embedded in knitting gaps of fingers of the glove core, the finger rubber-dipped layer, in percentage by weight of components, comprises: 93.3-95.8% of a main rubber, 0.8-1.2% of sulfur, 1-1.5% of zinc oxide, 1-1.2% of an ultra-fast rubber vulcanization accelerator, 0.2-0.5% of a peroxide decomposer, 1-2% of a wetting agent, and 0.2-0.3% of an alkali swelling thickener, and the palm rubber-dipped layer, in percentage by weight of components, comprises: 85.8-90.8% of a main rubber, 1-1.5% of sulfur, 2.5-3% of zinc oxide, 0.5-0.8% of an ultra-fast rubber vulcanization accelerator, 1-1.5% of titanium dioxide, 3-5% of white carbon black, 0.5-1% of an anionic surfactant, 0.5-1% of a vulcanization activator, and 0.2-0.4% of an emulsifier.

A method for producing the above rubber-dipped glove with wear-resistant fingers, comprising the following specific steps:
S1, preparing a rubber material of a finger rubber-dipped layer: a main rubber, sulfur, zinc oxide, an ultra-fast rubber vulcanization accelerator, a peroxide decomposer, a wetting agent and an alkali swelling thickener are mixed in set proportions and dispersed uniformly, wherein the main rubber is one of nitrile rubbers, water-based PU resins, and water-based butyl latexes; the ultra-fast rubber vulcanization accelerator is zinc diethyl dithiocarbamate; the peroxide decomposer is zinc dibutyl dithiocarbamate; the wetting agent is one of alkyl sulfates, sulfonates, fatty acids or fatty acid ester sulfates, carboxylic acid soaps, and phosphates, or a mixture thereof; and the alkali swelling thickener is one of hydrophobically modified soluble acrylic emulsions, hydrophobically modified cellulose ethers, and nonionic polyurethanes;
S2, preparing a rubber material of a palm rubber-dipped layer: a main rubber, sulfur, zinc oxide, an ultra-fast rubber vulcanization accelerator, titanium dioxide, white carbon black, an anionic surfactant, a vulcanization activator and an emulsifier are mixed in set proportions and dispersed uniformly, wherein the main rubber is one of nitrile rubbers, water-based PU resins, and water-based butyl latexes; the ultra-fast rubber vulcanization accelerator is zinc diethyl dithiocarbamate; the anionic surfactant is Turkish red oil; the vulcanization activator is triethanolamine; and the emulsifier is sodium carboxymethylcellulose;
S3. mold sleeving: a glove core is first sleeved on a hand mold, and then the glove core on the hand mold is preheated, where the temperature for preheating is controlled at 40-50° C.;
S4. rubber-dipping of glove fingers: fingers of the glove core are first dipped in a coagulator, air dried for 1-2 minutes, and then dipped in the finger rubber material prepared in S1, followed by dripping of the excess rubber material and shaking the hand mold to make the dipping rubber material even, the finger rubber material having a viscosity of 100-200 mpa·s, wherein the coagulator is one of a calcium nitrate-methanol solution with a concentration of 0.5-2%, and a glacial acetic acid-methanol solution with a concentration of 1.5-3%;
S5. oven drying treatment: the glove with the fingers dipped with the finger rubber-dipped layer is putted into an oven for oven drying, where the temperature for oven drying is controlled at 40-60° C.;
S6. glove dipping: the glove with the fingers dipped with the finger rubber-dipped layer in whole is first dipped in a coagulator, air dried for 1-2 minutes, and then dipped in the palm rubber material prepared in S2, followed by dripping of the excess rubber material and shaking the hand mold to make the dipping rubber material even, wherein the coagulator is one of a calcium nitrate-methanol solution with a concentration of 1-3%, and a glacial acetic acid-methanol solution with a concentration of 2-5%, and the glove with the fingers dipped with the finger rubber-dipped layer is dipped at the following position: a palm surface alone of the glove, a palm surface and a portion of a hand back of the glove, or the entire glove;
S7. soaking: the glove dipped with the finger rubber-dipped layer and the palm rubber-dipped layer is immersed in an acid-methanol solution with a concentration of 5-10% for soaking, and after soaking, the glove is salt-sprayed or left untreated;
S8. preheating: the soaked or salt-sprayed glove is putted into an oven for curing, where the temperature for curing is controlled at 65-75° C., and the time for curing is 15-40 minutes;
S9. soaking and washing: the cured glove is soaked and washed in warm water at 40-60° C., where the time for soaking and washing is 0.5-1 hour; and
S10. ripening: the soaked and washed glove is oven dried at a low temperature of 60-80° C. for 20-40 minutes and then at a high temperature of 110-115° C. for 50-70 minutes, and after oven drying, the rubber-dipped glove with wear-resistant fingers is obtained.

Compared with the prior art, the beneficial effects of the present invention are described below.

1. The present invention, by rubber-dipping in a manner of embedding plus fixing, enables the fingers of the rubber-dipped glove to have the wear resistance and durability, as well as anti-toxic and anti-chemical functions, which effectively improves the practicality of the rubber-dipped glove. With the configuration in which the finger rubber-dipped layer is embedded within the knitting gaps of the fingers of the glove core, the fingers of the glove are made wear-resistant without increased thickness, which effectively improves the flexibility of the fingers of the rubber-dipped glove in actual use, ensuring the wearer's flexibility in operation, and also makes it easy to identify the type of the glove. By adding the ultra-fast rubber vulcanization accelerator, the peroxide decomposer and the alkali swelling thickener in the finger rubber-dipped layer, not only the stickiness of the finger rubber-dipped layer can be effectively reduced, such that the rubber material of the finger rubber-dipped layer can be only embedded within the knitting gaps of the fingers of the glove core and not stick to the external surface of the fingers of the glove core, but also the wear resistance and durability of the finger rubber-dipped layer can be effectively improved, such that wear resistance of the fingers of the rubber-dipped glove can reach 12,000-16,000 revolutions under European standard EN388 certification, and the durability effect can reach 3,000-3,200 cycles, which effectively improves the wear resistance and durability of the rubber-dipped glove in actual use, thus ensuring the stability and safety of the wearer in operation. Further, with the configuration in which the palm rubber-dipped layer is fixed on the surface of the finger rubber-dipped layer and the external surface of the glove core, the rubber-dipped glove is made to have only one rubber-dipped layer in appearance, with no sense of layering, which effectively improves the aesthetics of the rubber-dipped glove, so that the wearer is more willing to wear and use the glove.

2. The present invention, by utilizing the figure rubber material having a viscosity of 100-200 mpa·s, makes the finger rubber material only embedded within the knitting gaps of the fingers of the glove core without increasing its thickness, which effectively improves the flexibility of the fingers of the rubber-dipped glove in actual use, ensuring the flexibility of the wearer in operation, while realizing anti-toxic and anti-chemical functions of the rubber-dipped glove with the finger rubber material embedded within the knitting gaps of the fingers of the glove core, which effectively improves the practicality of the rubber-dipped gloves.

3. The present invention, by dipping in the coagulator of the calcium nitrate-methanol solution or glacial acetic acid-methanol solution before rubber-dipping the glove, makes the finger rubber material and the palm rubber material easier to adhere to the glove core, which effectively improves the effect and efficiency of rubber-dipping of the rubber-dipped glove. Further, by the soaking treatment of immersing the glove in the acid-methanol solution after rubber-dipping, the adhesiveness of the finger rubber-dipped layer and the palm rubber-dipped layer is effectively improved, ensuring the wear resistance and durability of the rubber-dipped glove.

4. The present invention, by using the ripening method of low-temperature oven drying and then high-temperature oven drying, effectively improves the overall wear resistance of the rubber-dipped glove, such that the overall wear resistance of the rubber-dipped glove can reach 8,500-11,000 revolutions under European standard EN388 certification, which effectively improves the wear resistance of the rubber-dipped glove in whole in actual use, thus ensuring the stability and safety of the wearer in operation.

### BRIEF DESCRIPTION OF THE DRAWINGS

FIG. 1 is a flow schematic diagram of a rubber-dipping process for a rubber-dipped glove of the present invention.

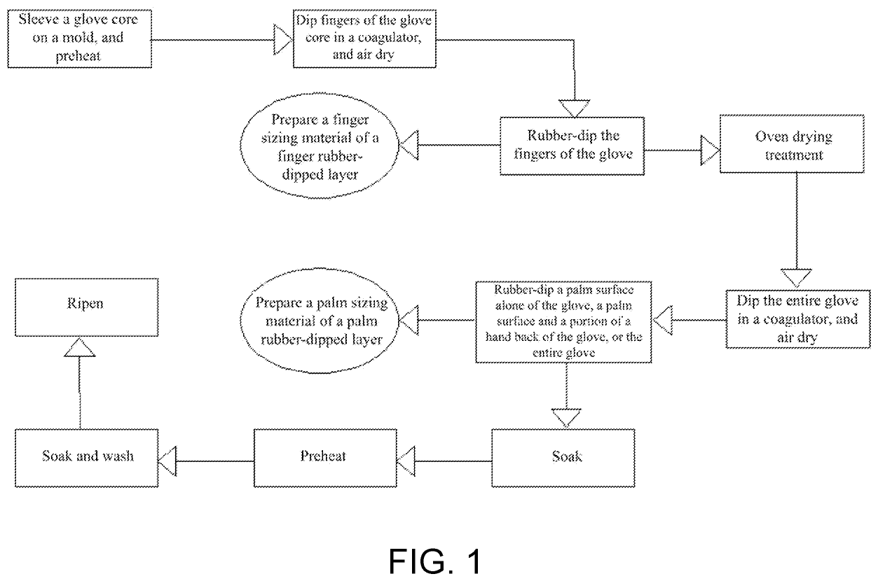

FIG. 2 is a structural schematic diagram of a front side of the rubber-dipped glove of the present invention.

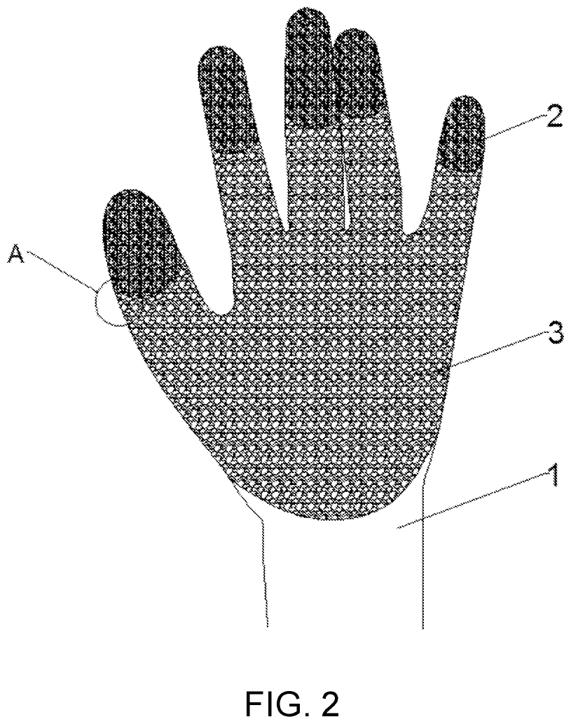

FIG. 3 is a structural schematic diagram of a back side of the rubber-dipped glove of the present invention.

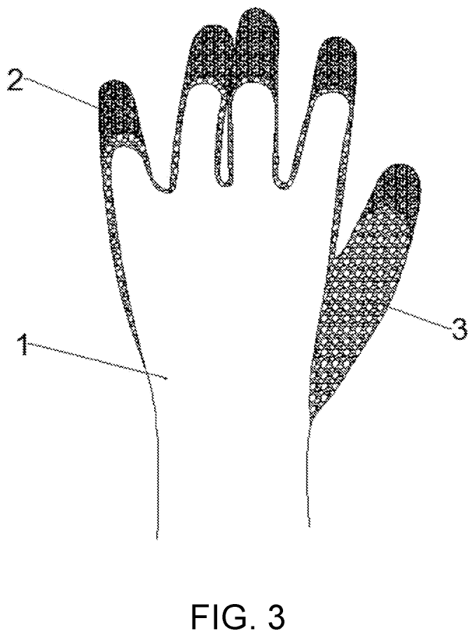

FIG. 4 is an enlarged structural schematic diagram of a region A in FIG. 2.

FIG. 5 is a structural schematic diagram of a lateral section of FIG. 4.

In the figures: 1. Glove core; 2. Finger rubber-dipped layer; 3. Palm rubber-dipped layer.

### DESCRIPTION OF THE EMBODIMENTS

The following examples are used for further illustrating the content of the present invention, and not intended to limit the application of the present invention.

### Example 1

First, nitrile rubber was selected as a main rubber (the main rubbers used in the finger rubber-dipped layer 2 and the palm rubber-dipped layer 3 may be the same or different), zinc diethyl dithiocarbamate as an ultra-fast rubber vulcanization accelerator, zinc dibutyl dithiocarbamate as a peroxide decomposer, a sulfonate as a wetting agent, and a hydrophobically modified soluble acrylic emulsion as an alkali swelling thickener, Turkish red oil as an anionic surfactant, triethanolamine as a vulcanization activator, sodium carboxymethylcellulose as an emulsifier, a calcium nitrate-methanol solution with a concentration of 0.5-2% as a coagulator for the fingers of the glove, and a calcium nitrate-methanol solution with a concentration of 1-3% as a coagulator for the glove in whole.

Then, the following were weighed in percentage by weight: 95.41% nitrile rubber, 0.9% sulfur, 1.1% zinc oxide, 1.03% zinc diethyl dithiocarbamate, 0.22% zinc dibutyl dithiocarbamate, 1.13% sulfonate, and 0.21% hydrophobically modified soluble acrylic emulsion, and the above components were putted into a rubber-dipping container for mixing and dispersing uniformly, to prepare a finger rubber material of the finger rubber-dipped layer 2, the finger rubber material having a viscosity of only 100-200 mpa·s.

Thereafter, again, the following were weighed in percentage by weight: 89.6% nitrile rubber, 1.0% sulfur, 2.53% zinc oxide, 0.55% zinc diethyl dithiocarbamate, 1.2% titanium dioxide, 3.4% white carbon black, 0.7% Turkish red oil, 0.66% triethanolamine, and 0.36% sodium carboxymethyl cellulose, and the above components were putted into a rubber-dipping container for mixing and dispersing uniformly to prepare a palm rubber material of the palm rubber-dipped layer 3.

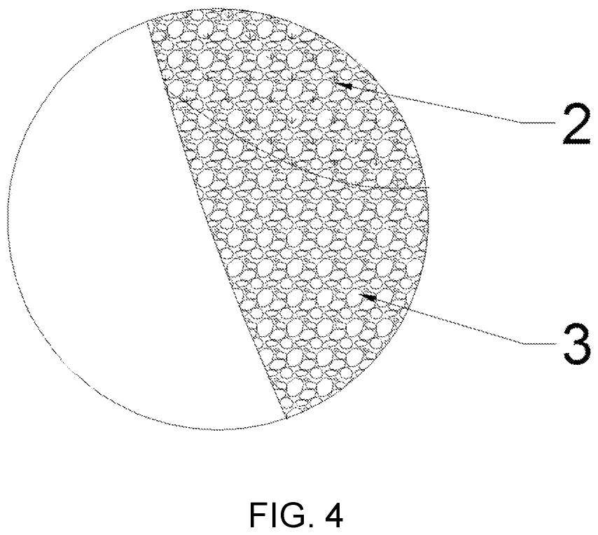

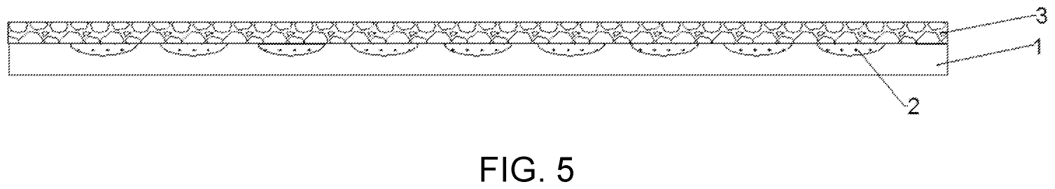

Then, the glove core 1 was sleeved on a hand mold, and the glove core on the hand mold was preheated, where the temperature for preheating was controlled at 40-50° C.; then, the fingers of the glove core 1 were dipped in a calcium nitrate-methanol solution with a concentration of 0.5-2% for 5-10 seconds, taken out for air drying for 1-2 minutes, then dipped in the finger rubber material having a viscosity of only 100-200 mpa·s prepared above, where it was ensured that the finger rubber material only covers partial areas between the fingers of the glove core 1. Then, the glove was lift up slowly for dripping of the excess rubber material and shaking the hand mold to make the dipping rubber material even, such that the excess finger rubber material dropped back into the rubber-dipping container, where it was ensured that the finger rubber-dipped layer 2 could be uniformly embedded within the knitting gaps of the fingers of the glove. Then, the glove with the fingers dipped with the finger rubber-dipped layer 2 was putted into an oven at 40-60° C. for oven drying. After oven drying, the glove with the fingers dipped with the finger rubber-dipped layer 2 in whole was immersed in the calcium nitrate-methanol solution with a concentration of 1-3% for 5-10 seconds, taken out for air drying for 1-2 minutes. Then, a palm surface alone of the glove, a palm surface and a portion of a hand back of the glove, or the entire glove was dipped in the palm rubber material prepared above. Then, the glove was lift up slowly for dripping of the excess rubber material and shaking the hand mold to make the dipping rubber material even, such that the excess palm rubber material dropped back into the rubber-dipping container, where it was ensured that the palm rubber-dipped layer 3 could be uniformly fixed on the surface of the finger rubber-dipped layer 2 and the external surface of the glove core 1 (when the palm of the glove was rubber-dipped, a small portion of the finger rubber-dipped layer 2 could be exposed on the back of the finger part of the glove to facilitate the wearer to identify the type of the glove). Then, the glove dipped with the finger rubber-dipped layer 2 and the palm rubber-dipped layer 3 was further immersed in the acid-methanol solution with a concentration of 5-10% for soaking, and after soaking, the glove could be salt-sprayed or left untreated. Then, the soaked or salt-sprayed glove was putted into an oven at 65 to 75° C. for curing for 15-40 minutes. After the curing, the glove was again soaked in warm water at 40-60° C. for soaking and washing for 0.5-1 hour. After the soaking and washing, finally, the glove was oven dried at a low temperature of 60-80° C. for 20-40 minutes, and then oven dried at a high temperature of 110-115° C. for 50-70 minutes. After oven drying, the rubber-dipped glove with wear-resistant fingers was obtained (at this point, the finger rubber-dipped layer 2 of the rubber-dipped layers of the rubber-dipped glove is wrapped inside the palm rubber-dipped layer 3, as shown in FIGS. 4 and 5). The rubber-dipped glove, obtained by rubber-dipping in the manner of embedding plus fixing, can have improved wear resistance and durability, such that under European standard EN388 certification, the wear resistance of the palm can reach 9,200 revolutions, and the wear resistance of the fingertips can reach 13,500 revolutions, and the durability effect of the fingers of the rubber-dipped glove can reach 3,100 cycles.

### Comparative Example 1

In this example, a rubber-dipped glove was produced. The rubber-dipping formula, rubber-dipping method and rubber-dipping process of the rubber-dipped glove were identical to those in Example 1, except that the fingers of the glove were not strengthened, so that the durability effect of the fingers of the rubber-dipped glove is only 820 cycles.

### Example 2

In this example, the configuration and the production method of the rubber-dipped glove with wear-resistant fingers were the same as those in Example 1, except that the dosing amounts of the finger rubber material and the palm rubber material are not identical, that is: the following were weighed in percentage by weight: 94.9% nitrile rubber, 0.96% sulfur, 1.2% zinc oxide, 1.14% zinc diethyl dithiocarbamate, 0.33% zinc dibutyl dithiocarbamate, 1.25% sulfonate, and 0.22% hydrophobically modified soluble acrylic emulsion, and the above components were putted into a rubber-dipping container for mixing and dispersing uniformly to prepare a finger rubber material of the finger rubber-dipped layer 2, the finger rubber material having a viscosity of only 100-200 mpa·s.

Again, the following were weighed in percentage by weight: 88.7% nitrile rubber, 1.1% sulfur, 2.69% zinc oxide, 0.72% zinc diethyl dithiocarbamate, 1.35% titanium dioxide, 3.5% white carbon black, 0.88% Turkish red oil, 0.69% triethanolamine, and 0.37% sodium carboxymethyl cellulose, and the above components were putted into a rubber-dipping container for mixing and dispersing uniformly to prepare a palm rubber material of the palm rubber-dipped layer 3.

The rubber-dipped glove, obtained using the finger rubber material and the palm rubber material prepared above and by rubber-dipping in the manner of embedding plus fixing, can have improved wear resistance and durability, such that under European standard EN388 certification, the wear resistance of the palm can reach 9800 revolutions, and the wear resistance of the fingertips can reach 14100 revolutions, and the durability effect of the fingers of the rubber-dipped glove can reach 3170 cycles.

### Comparative Example 2

In this example, a rubber-dipped glove was produced. The rubber-dipping formula, rubber-dipping method and rubber-dipping process of the rubber-dipped glove were identical to those in Example 2, except that the fingers of the glove were not strengthened by rubber-dipping, so that the durability effect of the fingers of the rubber-dipped glove is only 840 cycles.

### Example 3

In this example, the configuration and the production method of the rubber-dipped glove with wear-resistant fingers were the same as those in Example 1, except that the dosing amounts of the finger rubber material and the palm rubber material are not identical, that is: the following were weighed in percentage by weight: 94.16% nitrile rubber, 1.0% sulfur, 1.33% zinc oxide, 1.19% zinc diethyl dithiocarbamate, 0.38% zinc dibutyl dithiocarbamate, 1.67% sulfonate, and 0.27% hydrophobically modified soluble acrylic emulsion, and the above components were putted into a rubber-dipping container for mixing and dispersing uniformly to prepare a finger rubber material of the finger rubber-dipped layer 2, the finger rubber material having a viscosity of only 100-200 mpa·s.

Again, the following were weighed in percentage by weight: 87.59% nitrile rubber, 1.4% sulfur, 2.72% zinc oxide, 0.75% zinc diethyl dithiocarbamate, 1.46% titanium dioxide, 4.1% white carbon black, 0.92% Turkish red oil, 0.77% triethanolamine, and 0.29% sodium carboxymethyl cellulose, and the above components were putted into a rubber-dipping container for mixing and dispersing uniformly to prepare a palm rubber material of the palm rubber-dipped layer 3.

The rubber-dipped glove, obtained using the finger rubber material and the palm rubber material prepared above and by rubber-dipping in the manner of embedding plus fixing, can have improved wear resistance and durability, such that under European standard EN388 certification, the wear resistance of the palm can reach 10000 revolutions, and the wear resistance of the fingertips can reach 14700 revolutions, and the durability effect of the fingers of the rubber-dipped glove can reach 3190 cycles.

### Comparative Example 3

In this example, a rubber-dipped glove was produced. The rubber-dipping formula, rubber-dipping method and rubber-dipping process of the rubber-dipped glove were identical to those in Example 2, except that the fingers of the glove were not strengthened by rubber-dipping, so that the durability effect of the fingers of the rubber-dipped glove is only 880 cycles.

The following is a statistical table of the wear resistance data and durability data of Examples 1-3 and Comparative Examples 1-3:

| | | | Compar- | | Compar- |
|---|---|---|---|---|---|
| | | Example | ative | Example | ative |
| Test Item | | 1 | Example 1 | 2 | Example 2 |
| Wear | Palm | 9,200 | / | 9800 | / |
| resis- | | revolutions | | revolutions | |
| tance | Fingertip | 13500 | | 14100 | |
| | part | revolutions | | revolutions | |
| Dura- | Finger | 3,100 | 820 cycles | 3170 | 840 cycles |
| bility | part | cycles | | cycles | |

| | Example | Comparative |
|---|---|---|
| Test Item | 3 | Example 3 |

| | | | |
|---|---|---|---|
| Wear | Palm | 10000 | / |
| resistance | | revolutions | |
| | Fingertip | 14700 | |
| | part | revolutions | |
| Durability | Finger | 3190 | 880 cycles |
| | part | cycles | |

It can be seen from the above table that, the rubber-dipped gloves with strengthened wear-resistant fingers produced in Examples 1-3 have much better durability than the rubber-dipped gloves with non-strengthened wear-resistant fingers produced in Comparative Examples 1-3. Therefore, the rubber-dipped gloves with strengthened wear-resistant fingers have the wear resistance and durability, as well as the anti-toxic and anti-chemical functions, while ensuring a wearer's flexibility, stability and safety in actual use. Moreover, the rubber-dipped gloves have an external surface with no sense of layering and good in aesthetics, and thus the wearer is more willing to wear them.

What is claimed is:

1. A rubber-dipped glove with wear-resistant fingers, comprising a glove core and rubber-dipped layers comprising a finger rubber-dipped layer and a palm rubber-dipped layer, wherein the palm rubber-dipped layer is fixed on surfaces of the glove core and the finger rubber-dipped layer, the finger rubber-dipped layer is embedded within knitting gaps of fingers of the glove core, the finger rubber-dipped layer comprises a main rubber, sulfur, zinc oxide, an ultra-fast rubber vulcanization accelerator, a peroxide decomposer, a wetting agent and an alkali swelling thickener, and the palm rubber-dipped layer comprises a main rubber, sulfur, zinc oxide, an ultra-fast rubber vulcanization accelerator, titanium dioxide, white carbon black, an anionic surfactant, a vulcanization activator and an emulsifier.

2. The rubber-dipped glove with wear-resistant fingers according to claim 1, wherein the finger rubber-dipped layer, in percentage by weight of components, comprises: 93.3-95.8% of the main rubber, 0.8-1.2% of the sulfur, 1-1.5% of zinc oxide, 1-1.2% of the ultra-fast rubber vulcanization accelerator, 0.2-0.5% of the peroxide decomposer, 1-2% of the wetting agent, and 0.2-0.3% of the alkali swelling thickener.

3. The rubber-dipped glove with wear-resistant fingers according to claim 1, wherein the palm rubber-dipped layer, in percentage by weight of components, comprises: 85.8-90.8% of the main rubber, 1-1.5% of the sulfur, 2.5-3% of the zinc oxide, 0.5-0.8% of the ultra-fast rubber vulcanization accelerator, 1-1.5% of the titanium dioxide, 3-5% of the white carbon black, 0.5-1% of the anionic surfactant, 0.5-1% of the vulcanization activator, and 0.2-0.4% of the emulsifier.

4. A method for producing the rubber-dipped glove with wear-resistant fingers according to claim 1, the method for producing the rubber-dipped glove with wear-resistant fingers comprising the following steps:
S1, preparing a rubber material of the finger rubber-dipped layer: the main rubber, the sulfur, the zinc oxide, the ultra-fast rubber vulcanization accelerator, the peroxide decomposer, the wetting agent and the alkali swelling thickener are mixed in set proportions and dispersed uniformly;
S2, preparing a rubber material of the palm rubber-dipped layer: the main rubber, the sulfur, the zinc oxide, the ultra-fast rubber vulcanization accelerator, the titanium dioxide, the white carbon black, the anionic surfactant, the vulcanization activator and the emulsifier are mixed in set proportions and dispersed uniformly;
S3, mold sleeving;
S4, rubber-dipping of glove fingers: the fingers of the glove core are first dipped in a coagulator, air dried, and then dipped in the finger rubber material prepared in S1, followed by dripping of the excess rubber material and shaking a hand mold to make the dipping rubber material even, the finger rubber material having a viscosity of 100-200 mpa·s;
S5, oven drying treatment;
S6, glove dipping: the glove with the fingers dipped with the finger rubber-dipped layer in whole is first dipped in a coagulator, air dried, and then dipped in the palm rubber material prepared in S2, followed by dripping of the excess rubber material and shaking the hand mold to make the dipping rubber material even;
S7, soaking;
S8, preheating;
S9, soaking and washing; and
S10, ripening: the soaked and washed glove is oven dried at a low temperature and then at a high temperature, and after oven drying, the rubber-dipped glove with wear-resistant fingers is obtained.

5. The method for producing the rubber-dipped glove with wear-resistant fingers according to claim 4, wherein in S1, the main rubber is one of nitrile rubbers, water-based PU resins, and water-based butyl latexes; the ultra-fast rubber vulcanization accelerator is zinc diethyl dithiocarbamate; the peroxide decomposer is zinc dibutyl dithiocarbamate; the wetting agent is one of alkyl sulfates, sulfonates, fatty acids or fatty acid ester sulfates, carboxylic acid soaps, and phosphates, or a mixture thereof; and the alkali swelling thickener is one of hydrophobically modified soluble acrylic emulsions, hydrophobically modified cellulose ethers, and nonionic polyurethanes.

6. The method for producing the rubber-dipped glove with wear-resistant fingers according to claim 4, wherein in S2, the main rubber is one of nitrile rubbers, water-based PU resins, and water-based butyl latexes; the ultra-fast rubber vulcanization accelerator is zinc diethyl dithiocarbamate; the anionic surfactant is Turkish red oil; the vulcanization activator is triethanolamine; and the emulsifier is sodium carboxymethylcellulose.

7. The method for producing the rubber-dipped glove with wear-resistant fingers according to claim 4, wherein in S3, the mold sleeving is performed as follows: the glove core is first sleeved on the hand mold, and then the glove core on the hand mold is preheated, where a temperature for preheating is controlled at 40-50° C.

8. The method for producing the rubber-dipped glove with wear-resistant fingers according to claim 4, wherein in S4, the coagulator is one of a calcium nitrate-methanol solution with a concentration of 0.5-2%, and a glacial acetic acid-methanol solution with a concentration of 1.5-3%; and a time for air drying is 1-2 minutes.

9. The method for producing the rubber-dipped glove with wear-resistant fingers according to claim 4, wherein in S5, the oven drying is performed as follows: the glove with the fingers dipped with the finger rubber-dipped layer is putted into an oven for oven drying, where a temperature for oven drying is controlled at 40-60° C.

10. The method for producing the rubber-dipped glove with wear-resistant fingers according to claim 4, wherein in S6, the coagulator is one of a calcium nitrate-methanol solution with a concentration of 1-3%, and a glacial acetic acid-methanol solution with a concentration of 2-5%; and a time for air drying is 1-2 minutes.

11. The method for producing the rubber-dipped glove with wear-resistant fingers according to claim 4, wherein in S6, the glove with the fingers dipped with the finger rubber-dipped layer is dipped at the following position: a palm surface alone of the glove, a palm surface and a portion of a hand back of the glove, or the entire glove.

12. The method for producing the rubber-dipped glove with wear-resistant fingers according to claim 4, wherein in S7, the soaking is performed as follows: the glove dipped with the finger rubber-dipped layer and the palm rubber-dipped layer is immersed in an acid-methanol solution with a concentration of 5-10% for soaking, and after soaking, the glove is salt-sprayed or left untreated.

13. The method for producing the rubber-dipped glove with wear-resistant fingers according to claim 4, wherein in S8, the preheating is performed as follows: the soaked or salt-sprayed glove is putted into an oven for curing, where a temperature for curing is controlled at 65-75° C., and a time for curing is 15-40 minutes.

14. The method for producing the rubber-dipped glove with wear-resistant fingers according to claim 4, wherein in S9, the soaking and washing is performed as follows: the cured glove is soaked and washed in warm water at 40-60° C., where a time for soaking and washing is 0.5-1 hour.

15. The method for producing the rubber-dipped glove with wear-resistant fingers according to claim 4, wherein in S10, a temperature for low-temperature oven drying is 60-80° C., a time for low-temperature oven drying is 20-40 minutes, a temperature for high-temperature oven drying is 110-115° C., and a time for high-temperature oven drying is 50-70 minutes.
